(19) United States
(12) Patent Application Publication
(10) Pub. No.: US 2006/0130871 A1
(43) Pub. Date: Jun. 22, 2006

(54) Megasonic cleaner having double cleaning probe and cleaning method

(75) Inventors: Kyung-Seuk Hwang, Suwon-si (KR); Sun-Yong Lee, Seoul (KR); Dong-Chul Heo, Gunpo-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/268,285

(22) Filed: Nov. 4, 2005

(30) Foreign Application Priority Data
Dec. 20, 2004 (KR) 2004-108794

(51) Int. Cl. B08B 3/12; C23G 1/00; B08B 7/00; B08B 3/00

(52) U.S. Cl. 134/1; 134/149; 134/184; 134/33; 134/2

(57) ABSTRACT

A megasonic cleaner includes a rotatable wafer supporting member for supporting a wafer; a cleaning solution supply member for supplying a cleaning solution to a wafer placed on the wafer supporting member; at least two vibration transfer members for agitating cleaning solutions supplied to different areas of the wafer placed on the wafer supporting member; and a vibration generating member for oscillating the at least two vibration transfer members. The cleaner has at least two quartz rods for transferring oscillation energy. Using the quartz rods, oscillation energy is transferred to respective areas of a wafer to clean the wafer. Thus, a difference between cleaning efficiencies of wafer edge and center is reduced or substantially eliminated to achieve a uniform cleaning efficiency on an entire surface of the wafer.

### PRIORITY STATEMENT

This application claims priority to Korean Patent Application No. 2004-108794, filed on Dec. 20, 2004 in the Korean Intellectual Property Office, the disclosure of which is incorporated by reference in its entirety herein.

### BACKGROUND OF THE INVENTION

1. Field of the Invention

The present invention relates to a cleaning apparatus and a method using the cleaning apparatus. More specifically, the present invention is directed to a megasonic cleaning apparatus having a double cleaning probe to achieve uniform cleaning efficiency and a cleaning method.

2. Description of Related Art

As the integration density of semiconductor devices increases, the feature sizes of patterns and the space between the patterns in the semiconductor devices correspondingly are becoming smaller. The presence of contaminant particles on a wafer surface during its manufacturing process may lead to undesirable patterns; consequently, the presence of contaminants in the fine patterns affects the functions of a semiconductor device. As fine patterns are reduced to the size of at most 1 micrometer, the acceptable threshold size of contaminant particles is also lowered. However, these miniscule contaminant particles are not readily removed by conventional means. In this regard, numerous efforts have been made for enhancing wafer surface cleaning efficiency. In these efforts, one crucial factor is to address the need to effectively apply a force for overcoming the viscosity of contaminant particles on a wafer.

FIG. 1 shows a conventional megasonic cleaning apparatus for removal of contaminant particles. A flow of a liquid such as deionized water (DI water) 30 is agitated at an extremely high frequency towards a surface of a wafer W. The energy for agitating the DI water is generated by an energy generator 10, such as a piezoelectric transducer. The energy is transferred to the DI water 30 through a quartz rod 20; thereby, agitating the DI water 30 at a high frequency. Subsequently, the agitated DI water 30 vibrates the wafer W to dislodge contaminant particles from the surface of the wafer W. The entire surface of the wafer W is cleaned while the wafer W rotates in conjunction with the rotation of a support 40.

Another problem in the prior art is the variation of cleaning efficiency which varies with the energy differences of the oscillating probe. The probe's longitudinal oscillation starts from the edge of the wafer W; hence an energy transferred thereby to the edge of the wafer W is greater than an energy transferred to the center of the wafer W. This leads to defects of wafers disposed on points of lower cleaning efficiency. The wafer defects due to differing cleaning efficiencies result in a decrease in manufacturing yield.

### SUMMARY OF THE INVENTION

Exemplary embodiments of the present invention are directed to a megasonic cleaner and a cleaning method. According to an aspect of the invention, a megasonic cleaner has at least two quartz rods for transferring oscillation energy. Using the quartz rods, oscillation energy is transferred to surface areas of a wafer to clean the wafer, -eliminating differences between the cleaning efficiencies applied on a wafer's edge and its center.

An exemplary embodiment of the present invention provides a cleaner including a rotatable wafer supporting member for supporting a wafer; a cleaning solution supply member for supplying a cleaning solution to a wafer placed on the wafer supporting member; at least two vibration transfer members for agitating cleaning solutions supplied to the different areas of a wafer placed on the wafer supporting member; and a vibration generating member for oscillating the at least two vibration transfer members.

In some embodiments of the present invention, the vibration generating member includes an oscillator for simultaneously oscillating the at least two vibration transfer members.

In some embodiments of the present invention, the vibration generating member includes at least two oscillators for independently oscillating the at least two vibration transfer members.

In some embodiments of the present invention, the oscillators oscillate the vibration transfer members simultaneously or independently.

In some embodiments of the present invention, the vibration transfer member includes a first probe for agitating a cleaning solution supplied to an inner area of, including the center, of a wafer; and a second probe for agitating a cleaning solution supplied to an outer area surrounding the inner area of a wafer. The first probe has a bent or stepped shape, and the second probe has a straight shape. The first probe is bent at an angle range of about 10 degrees to 90 degrees.

Another exemplary embodiment of the present invention provides a cleaner including a cleaning vessel having a bottom where a drain port is formed; a wafer support disposed in the cleaning vessel for supporting a wafer; a driver combined with the wafer support for rotating a wafer; a nozzle for supplying a cleaning solution to a wafer; a cleaning probe including a first probe for agitating a cleaning solution supplied to an inner area near the center of a wafer using megasonic energy and a second probe for agitating a cleaning solution supplied to an outer area surrounding the inner area of a wafer using megasonic energy; and a generator including a first probe oscillator for oscillating the first probe using megasonic energy and a second probe oscillator for oscillating the second probe using megasonic energy.

In some embodiments of the present invention, the first probe has a vent or stepped shape and the second probe has a straight shape. The first probe is bent at an angle range of 10 degrees to 90 degrees. A tip of the first probe is disposed at the center of the wafer, and a tip of the second probe is disposed at a boundary portion of the inner and outer areas of the wafer.

In some embodiments of the present invention, the first and second probe oscillators oscillate the first and second probes using the same megasonic energy, respectively.

In some embodiments of the present invention, the first and second probe oscillators oscillate the first and second probes using different megasonic energies, respectively.

In some embodiments of the present invention, the first and second probe oscillators respectively_oscillate the first and second probes simultaneously or independently.

In some embodiments of the present invention, at least one of the first and second probes is made of any one material selected from the group consisting of sapphire, silicon carbide, boron nitride, vitreous carbon, quartz, and any combinations thereof.

In some embodiments of the present invention, the cleaning solution is any one material or mixture selected from the group consisting of deionized water (DI water), a mixture of ammonium hydroxide (NH₄OH), hydrogen peroxide (H₂O₂), and DI water (H₂O), a mixture of hydrofluoric acid (HF) and DI water (H₂O), a mixture of ammonium hydrogen fluoride (NH₄F), hydrofluoric acid (HF), and DI water (H₂O), a mixture of phosphoric acid (H₃PO₄) and DI water (H₂O), and any combinations thereof.

Another exemplary embodiment of the present invention provides a cleaning method including (a) placing a wafer on a rotatable wafer support; (b) rotating the wafer placed on the wafer support; (c) locating at least one of first and second probes on a surface of the wafer, the first probe cleaning an inner area including the center of the wafer and the second probe cleaning an outer area surrounding the inner area of the wafer; (d) supplying a cleaning solution to the wafer placed on the wafer support; and (e) oscillating at least one of the first and second probes using megasonic energy.

In some embodiments of the present invention, in step (c), the first and second probes are located on the surface of a wafer simultaneously or independently.

In some embodiments of the present invention, the step (e) includes step (e′) oscillating the first and second probes using the same megasonic energy.

In some embodiments of the present invention, in step (e′) the first and second probes are oscillated simultaneously or independently using the same megasonic energy.

In some embodiments of the present invention, the step (e) includes (e″) oscillating the first and second probes using different megasonic energies.

In some embodiments of the present invention, in step (e″) the first and second probes are oscillated simultaneously or independently using different megasonic energy.

### BRIEF DESCRIPTION OF THE DRAWINGS

FIG. 1 is a cross-sectional view of a conventional megasonic cleaner;

FIG. 2 is a cross-sectional view of a megasonic cleaner according to an embodiment of the present invention;

FIG. 3 is a cross-sectional view of a part of the megasonic cleaner according to an embodiment of the present invention;

FIG. 4 is a top plan view of a part of the megasonic cleaner according to an embodiment of the present invention; and

FIG. 5 is a cross-sectional view of a modified version of the megasonic cleaner according to an embodiment of the present invention.

### DETAILED DESCRIPTION OF PREFERRED EMBODIMENTS

The present invention will now be described more fully hereinafter with reference to the accompanying drawings, in which preferred embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the height of layers and regions are exaggerated for clarity. Like numbers refer to like elements throughout.

As illustrated in FIG. 2, a megasonic cleaner according to an embodiment of the invention includes a cleaning vessel 600, a wafer support 400 disposed in the cleaning vessel 600 to serve as a wafer supporting member for supporting a wafer W to be cleaned, a nozzle 500 serving as a cleaning solution supply member for supplying a cleaning solution 300 onto a surface of a wafer W to be placed on the wafer support 400, cleaning probes 210 and 220 each serving as a vibration transfer member for oscillating a cleaning solution 300 supplied onto a surface of a wafer W, and generators 120 and 220 each serving as a vibration generating member for generating oscillation energy to be transferred to the cleaning probes 210 and 220.

The cleaning vessel 600 has an open top. A nozzle 500 is disposed over the open top of the cleaning vessel 600 for supplying a cleaning solution into the cleaning vessel 600. A drain port 610 is formed at the bottom of the cleaning vessel 600 for draining a cleaning solution to the outside. A clear cleaning solution is continuously supplied onto a surface of a wafer W in the cleaning vessel 600 from the upside of the cleaning vessel through the nozzle 500. With a cleaning operation, a cleaning solution containing foreign substances is drained to the outside through the drain port 610.

A to-be-cleaned wafer W is placed on the wafer support 400 disposed in the cleaning vessel 600. Preferably, when being placed at a cleaning point on the wafer support 400, a wafer W is sufficiently near the cleaning probes 210 and 220. The cleaning probes 210 and 220 will be explained below in detail. A cleaning solution supplied between the cleaning probes 210 and 220 and the wafer W removes foreign substances on a surface of a wafer W or separates the foreign substances from the surface of a wafer W. Since the wafer support 400 is combined with a driver such as a motor 700, the wafer rotates in conjunction with the operation of the motor 700. Thus, the wafer W placed on the wafer support 400 also rotates at a predetermined rotation number during a cleaning process.

The cleaning probes 210 and 220 are positioned over a wafer W placed on the wafer support 400. The cleaning probes 210 and 220 apply a strong megasonic vibration to the cleaning solution supplied onto the wafer W through the nozzle 500. Cavitation bubbles are collapsed by the applied vibration to form gaps between foreign substances. Bubbles penetrate into the gaps and the bubbles are_collapsed to fully separate the foreign substances from the surface of the wafer W. The use of megasonic energy at megahertz (MHz) frequencies alleviates possible incursion of wafer damage resulting from cavitation or from the presence of contaminants that are less than 1 micrometer in size.

The cleaning solution is selected based on conditions of a cleaning process. It may include DI water (H₂O), to remove and to rinse foreign substances attached onto a wafer W. Alternatively, the cleaning solution may include a mixture of ammonium hydroxide (NH₄OH), hydrogen peroxide (H₂O₂), and DI water (H₂O), a mixture of hydrofluoric acid (HF) and DI water (H₂O), a mixture of ammonium hydrogen fluoride (NH₄F), hydrofluoric acid (HF), and DI water (H₂O), and a mixture of phosphoric acid (H₃PO₄) and DI water (H₂O). Any one of the foregoing cleaning solutions or any mixtures or combinations thereof may be used. Also, at controlled higher temperatures, the use of these aforementioned cleaning solutions can increase cleaning efficiency.

The cleaning probes 210 and 220 are in contact with a cleaning solution 300 supplied onto a wafer W. These cleaning probes may be hollow rods, each extending in a horizontal direction, i.e., at a radius direction of the wafer W and having, for example, a circular section. The size of the circular section is random. Since the cleaning probes 210 and 220 may have any shape suitable to oscillate the cleaning solution 300, the probes may have other shapes.

Preferably, at least one of the cleaning probes 210 and 220 or both of them,_are made of quartz. The material of the cleaning probes 210 and 220 depend on the cleaning solution used; hence, these may also include sapphire, silicon carbide, boron nitride, vitreous carbon and combinations thereof.

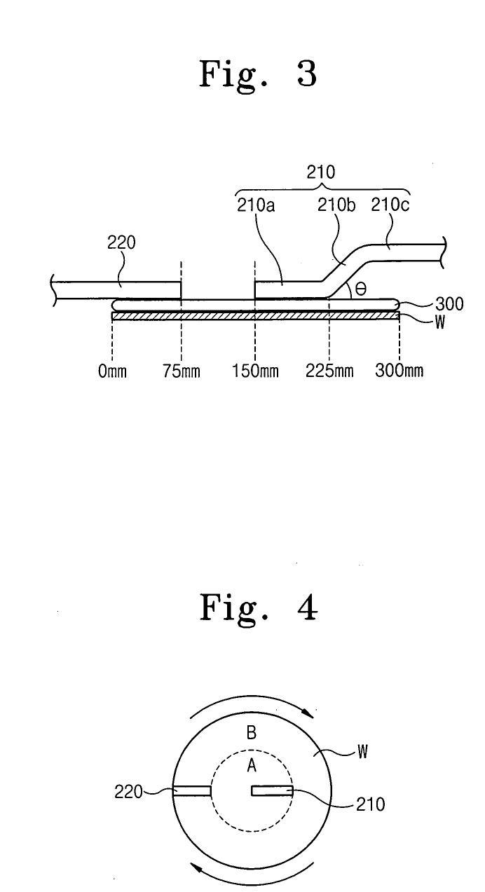

The first probe 210 applies megasonic waves to a cleaning solution 300 supplied to an inner area (A of FIG. 4) including the center of a wafer W. Accordingly, the first probe 210 is divided into a portion 210a which is in contact with a cleaning solution 300 supplied onto the inner area A of the wafer W, a portion 210c which is not in contact with a cleaning solution 300 of an outer area (B of FIG. 4) of the wafer W, and a portion 210b which interconnects the portions 210a and 210c, as illustrated in FIG. 3. Thus, the first probe 210 is bent at a predetermined angle θ. For example, the portions 210b and 210c of the probe 210 are not in direct contact with the cleaning solution 300. Therefore, the bent angle θ of the first probe 210 is preferably set to at least about 10 degrees and about 90 degrees.

The length of the portion 210a can be any length but, it is preferably half of a radius of a wafer W, both in consideration of the length of the second probe 220 and of a uniform cleaning efficiency. Thus, one end of the portion 210a is disposed at the center of the wafer W and the other end thereof is disposed at a boundary portion of the inner and outer areas A and B.

The second probe 220 applies megasonic waves to a cleaning solution 300 supplied to an area (B of FIG. 4) except the inner surface area (A of FIG. 4) of a wafer W. Accordingly, the second probe 220 includes only a portion 220 which is in contact with a cleaning solution 300 supplied onto an outer area (B of FIG. 4) surrounding the inner area (A of FIG. 4) of the wafer W. Thus, the second probe 220 has a straight line structure. For the second probe 220, a length of a portion that is in direct contact with the cleaning solution 300 can also be any length, but it is preferably half of a radius of a wafer W, both in consideration of the length of the first probe 210 and of a uniform cleaning efficiency. Thus, the end of the second probe 200 is disposed at a boundary portion of the inner and outer areas A and B.

The generators 110 and 120 are vibrators for generating vibration to be transferred to the cleaning probes 210 and 220 and these are coupled with one end, respectively of each of the cleaning probes 210 and 220. The generators 110 and 120 generate a high megahertz (MHz) frequency signal. Each of the generators 110 and 210 may include, for example, a piezoelectric transducer that converts electrical energy into physical vibration energy.

The generators 110 and 120 also include a first probe oscillator 110 for generating vibration to be transferred to the first probe 210 and a second probe oscillator 120 for generating vibration to be transferred to the second probe 220.

The first and second probe oscillators 110 and 120 may generate vibrations simultaneously or independently, at the same frequency or different frequencies. Thus, an entire surface area of a wafer W may be cleaned as a whole; and/or an inner area A or an outer area of B of a wafer may be cleaned separately, by the first and second probes 210 and 220 as shown in FIG. 4.

In reference to FIG. 3 and FIG. 4, for example, the diameter of a wafer to be cleaned is about 300 millimeters, and then the right and the left ends thereof are 0 and about 300 millimeters, respectively. —In FIG. 4, the first probe 210 agitates a cleaning solution 300 supplied to an inner area A of a wafer W, i.e., an area A ranging from about 150-millimeter point to about 225-millimeter point, to separate any foreign substances from a surface of the wafer W. The second probe 220 agitates a cleaning solution supplied to an outer area B of the wafer W, i.e., an area B ranging from 0-millimeter point to about 75-millimeter point to separate foreign substances from a surface of the wafer W. Since the first and second oscillators 210 and 220 may operate independently, the inner area A or the outer area B of the wafer W may be selectively cleaned. This double probe cleaning system achieves a uniform cleaning efficiency.

An exemplary cleaning process using an above-described megasonic cleaner will now be described. A wafer W to be cleaned is placed on a wafer support 400. A motor 700 operates to rotate the wafer support 400 and the wafer W placed thereon.

Cleaning probes 210 and 220 are located at cleaning points on the wafer W. The first probe 210 is located at an inner area A of the wafer W, and the second probe 220 is located at an outer area B thereof. When necessary, only one of the probes 210 or 220 or both of them are located on the wafer W or they are sequentially located on the wafer W.

When the cleaning probes 210 and 220 are located at a cleaning point, a cleaning solution 300 is supplied onto a surface of the wafer W through a nozzle 500. During a cleaning process, the cleaning solution 300 is continuously supplied. The wafer support 400 having a wafer W disposed thereon operates a motor 700, causing the wafer support to rotate and as such that the wafer W continues to rotate during the cleaning solution.

When the cleaning probes 210 and 220 are located at a cleaning point and the cleaning solution is supplied, generators 110 and 120 operate to oscillate the cleaning probes 210 and 220 at a megasonic wave at a high megahertz (MHz) frequency. The cleaning probes 210 and 220 may be oscillated at the same frequency or independently. Further, the cleaning probe 210 and 220 may be oscillated simultaneously or independently. As an example, to clean only an inner area A of the wafer W, only the first probe 210 is located at a cleaning point and vibration only at the first probe is needed.

The oscillated cleaning probes 210 and 220 agitate a cleaning solution 300 supplied onto a surface of the wafer W. The agitated cleaning solution 300 separates foreign substances from the surface of the wafer W. At this time, the wafer W continues to rotate and the cleaning solution 300 is continuously supplied onto the surface of the wafer W, as described above. The spent cleaning solution containing foreign substances separated from the surface of the wafer W is drained to the outside through a drain port 610, and a clear cleaning solution thereof, is supplied through the nozzle 500.

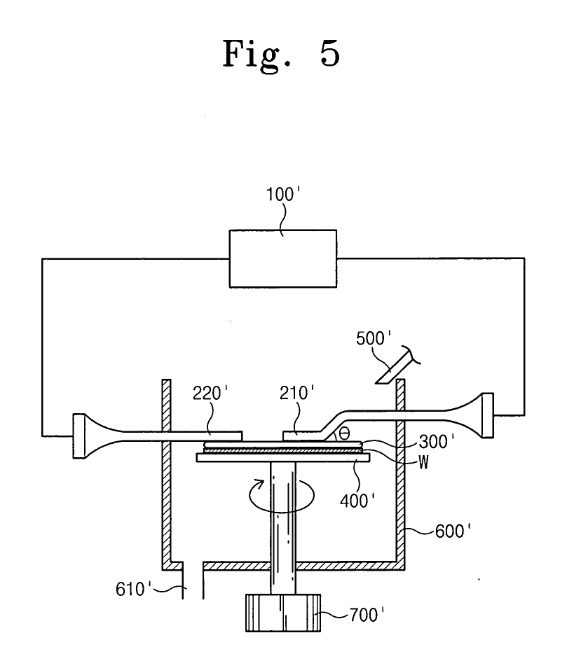

A megasonic cleaner according to another embodiment of the invention is illustrated in FIG. 5.

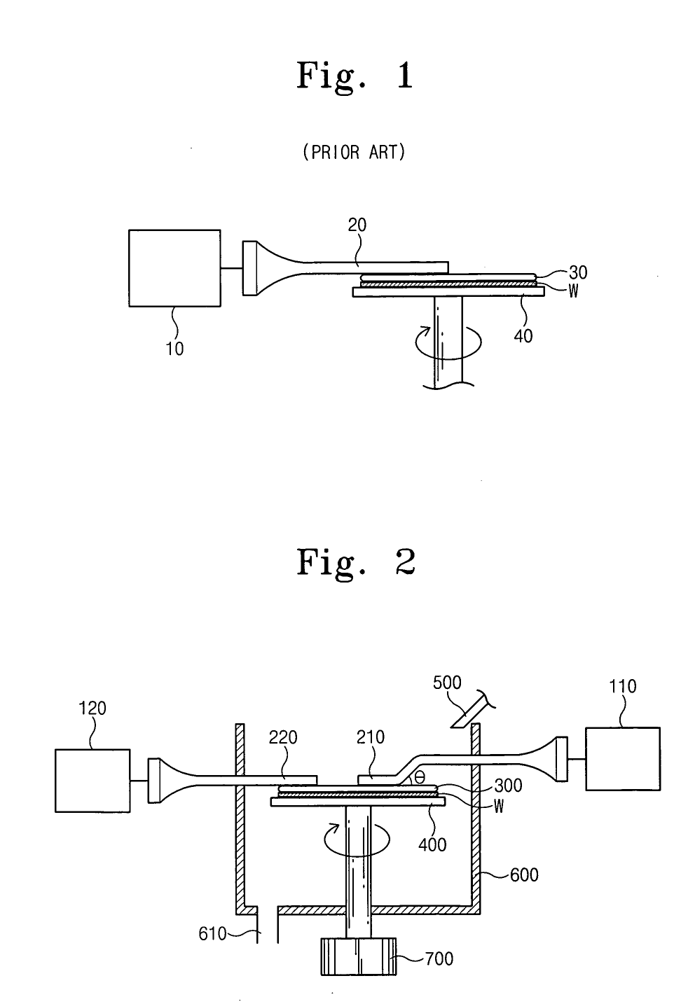

As illustrated in FIG. 5, there is only one probe oscillator 100′ that is a generator for oscillating a first probe 210′ and a second probe 220′. That is, one probe oscillator 100′ oscillates two cleaning probes 110′ and 120′ using the same megasonic energy. The other components and a cleaning method are identical to those described with references to FIG. 1 through FIG. 4 and these will not be described in further detail.

According to an embodiment of the present invention, a cleaner has at least two quartz rods for transferring oscillation energy. Using the quartz rods, oscillation energy is transferred to a cleaning solution to the respective areas of a wafer to clean the wafer. Thus, the difference between cleaning efficiencies at the edge of the wafer and its center is reduced or substantially eliminated to achieve a uniform cleaning efficiency on an entire surface of the wafer. As a result, manufacturing defects decrease, due to lesser wafer surface defects and production yield increases.

Other modifications and variations to the invention will be apparent to a person skilled in the art from the foregoing disclosure. Thus, while only certain embodiment of the invention has been specifically described herein, it will be apparent that numerous modifications may be made thereto without departing from the spirit and scope of the invention.

What is claimed is:

1. A cleaner comprising:
a rotatable wafer supporting member for supporting a wafer;
a cleaning solution supply member for supplying a cleaning solution to a wafer placed on the rotatable wafer supporting member;
at least two vibration transfer members for agitating cleaning solutions supplied to the different areas of the wafer placed on the rotatable wafer supporting member; and
a vibration generating member for oscillating the at least two vibration transfer members.

2. The cleaner as recited in claim 1, wherein the vibration generating member includes an oscillator for simultaneously oscillating the at least two vibration transfer members.

3. The cleaner as recited in claim 1, wherein the vibration generating member includes at least two oscillators for independently oscillating the at least two vibration transfer members.

4. The cleaner as recited in claim 3, wherein the oscillators oscillate the at least two vibration transfer members simultaneously or independently.

5. The cleaner as recited in claim 1, wherein each of the at least two vibration transfer member comprises:
a first probe for agitating a cleaning solution supplied to an inner area including the center of the wafer; and
a second probe for agitating a cleaning solution supplied to an outer area surrounding the inner area of the wafer.

6. The cleaner as recited in claim 5, wherein the first probe has a bent or stepped shape.

7. The cleaner as recited in claim 5, wherein the second probe has a straight shape.

8. The cleaner as recited in claim 5, wherein the first probe has a bent or stepped shape, and the second probe has a straight shape; and
a tip of the first probe is disposed at the center of the wafer, and a tip of the second probe is disposed at a boundary portion of the inner and outer areas of the wafer.

9. The cleaner as recited in claim 6, wherein the first probe is bent at an angle range of about 10 degrees to about 90 degrees.

10. A cleaner comprising:
a cleaning vessel having a bottom where a drain port is formed;
a rotatable wafer support disposed in the cleaning vessel for supporting a wafer;
a driver for rotating the wafer;
a nozzle for supplying a cleaning solution to the wafer;
a cleaning probe including a first probe for agitating a cleaning solution supplied to an inner area near the center of the wafer using megasonic energy and a second probe for agitating a cleaning solution supplied to an outer area surrounding the inner area of the wafer using megasonic energy; and
a generator including a first probe oscillator for oscillating the first probe and a second probe oscillator for oscillating the second probe.

11. The cleaner as recited in claim 10, wherein the first probe has a vent or stepped shape and the second probe has a straight shape.

12. The cleaner as recited in claim 11, wherein the first probe is bent at an angle range of about 10 degrees to about 90 degrees.

13. The cleaner as recited in claim 11, wherein a tip of the first probe is disposed at the center of the wafer, and a tip of the second probe is disposed at a boundary portion of the inner and outer areas of the wafer.

14. The cleaner as recited in claim 10, wherein the first and second probe oscillators oscillate the first and second probes at the same frequency.

15. The cleaner as recited in claim 14, wherein the first and second probe oscillators respectively oscillate the first and second probes simultaneously or independently.

16. The cleaner as recited in claim 10, wherein the first and second probe oscillators oscillate the first and second probes at different frequencies.

17. The cleaner as recited in claim 16, wherein the first and second probe oscillators respectively oscillate the first and second probes simultaneously or independently.

18. The cleaner as recited in claim 10, wherein at least one of the first and second probes is made of any one material selected from the group consisting of sapphire, silicon carbide, boron nitride, vitreous carbon, quartz, and any combinations thereof.

19. The cleaner as recited in claim 10, wherein the cleaning solution is any one material or mixture selected from the group consisting of deionized water (DI water), a mixture of ammonium hydroxide (NH₄OH), hydrogen peroxide (H₂O₂), and DI water (H₂O), a mixture of hydrofluoric acid (HF) and DI water (H₂O), a mixture of ammonium hydrogen fluoride_(NH₄F), hydrofluoric acid (HF), and DI water (H₂O), a mixture of phosphoric acid (H₃PO₄) and DI water (H₂O), and any combinations thereof.

20. A cleaning method comprising:
(a) placing a wafer on a rotatable wafer support;
(b) rotating the wafer placed on the rotatable wafer support;
(c) locating at least one of first and second probes on a surface of the wafer, the first probe cleaning an inner area including the center of the wafer and the second probe cleaning an outer area surrounding the inner area of the wafer;
(d) supplying a cleaning solution to the wafer placed on the rotatable wafer support; and
(e) oscillating at least one of the first and second probes using megasonic energy.

21. The method as recited in claim 20, wherein in (c), the first and second probes are located on the surface of the wafer simultaneously or independently.

22. The method as recited in claim 20, wherein the step (e) of oscillating further comprises: (e′) oscillating the first and second probes using the same megasonic energy.

23. The method as recited in claim 22, wherein in the (e′), the first and second probes are oscillated simultaneously or independently.

24. The method as recited in claim 20, wherein the step (e) of oscillating further comprises: (e″) oscillating the first and second probes at different frequencies.

25. The method as recited in claim 24, wherein in the (e″), the first and second probes are oscillated simultaneously or independently.

26. The method as recited in claim 20, further including: (f) draining spent cleaning solution through a drain port and continuously replenishing a cleaning solution to the wafer during the cleaning process.
